(19) United States
(12) Patent Application Publication
(10) Pub. No.: US 2014/0007550 A1
(43) Pub. Date: Jan. 9, 2014

(54) FILTER DEVICE FOR GAS FLOW LOADED WITH AEROSOLES AND/OR GASEOUS IODINE

(71) Applicant: Yit Germany GmbH, Munich (DE)

(72) Inventor: Hans Martinsteg, Roetgen (DE)

(73) Assignee: Yit Germany GmbH, Munich (DE)

(21) Appl. No.: 13/713,264

(22) Filed: Dec. 13, 2012

(30) Foreign Application Priority Data
Dec. 22, 2011 (DE) 10201 1056889.1

(51) Int. Cl. B01D 46/00

(52) U.S. Cl. CPC B01D 46/00
USPC 55/485; 55/495; 55/482

(57) ABSTRACT

The invention relates to a filter device for filtering a gas flow that is loaded with aerosols and/or gaseous radioactive iodine including a housing that is closed fluid tight, including at least one raw gas inlet, a clean gas outlet, at least one filter element including a filter medium, the filter element is arranged in the housing so that a gas flow to be filtered moves from the at least one raw gas inlet to the clean gas outlet only through the filter element, at least one tubular element penetrating the housing from a first pass-through cross-section to a second pass through cross-section which is arranged in vertical direction above the first pass through cross-section, so that an entire inner cavity of the tubular element is exclusively in contact with an ambient fluid surrounding the filter device.

### RELATED APPLICATIONS

This application claims priority from and incorporates by reference German patent application 10 2011 056 889.1, filed on Dec. 22, 2011.

### FIELD OF THE INVENTION

The invention relates to a filter device for filtering a gas flow that is loaded with radioactive aerosols and/or gaseous radioactive iodine including a housing that is closed fluid tight including at least one raw gas inlet, a clean gas outlet and at least one filter element including a filter medium which filter element is arranged in the housing so that the gas flow to be filtered moves from the at least one raw gas inlet exclusively through the filter element to the clean gas outlet.

### BACKGROUND OF THE INVENTION

Filter devices of the type recited supra are well known and are used for numerous applications in the field of nuclear technology, wherein the filter devices have to comply with the respective requirements of these applications.

A core meltdown generates large amounts of steam and non-condensable gases through evaporation of the cooling water from the primary cooling cycle of the reactor and through destruction of the concrete in the reactor foundation. This leads to a pressure buildup in the containment vessel which encloses the reactor and the components of the primary cycle.

In a pressurized water reactor of German design, the burst pressure of the containment vessel is reached within approximately 4 to 5 days after a core meltdown. The atmosphere of the containment vessel, due to natural deposition processes that take place without external measures, only includes fractions of the original amounts of radioactive aerosols formed by the core meltdown.

As a consequence of the Chernobyl accident, all power plants in Germany were equipped with pressure relief filters for the containment vessel in order to prevent an uncontrolled release of this residual activity through a sudden failure of the containment vessel and in order to further reduce the amount of radioactivity that is released.

In particular for the extreme conditions with gas temperatures up to 160° C. and pressures up to 9 bar in the containment vessel prevailing after a core meltdown, the nuclear research center in Karlsruhe has developed a filter system, the so-called dry filter method which reduces the environmental impact from radioactive aerosols and gaseous radioactive iodine by orders of magnitude.

The dry filter method uses a completely passive system, typically including:
metal fleece filters for retaining airborne radioactive aerosols;
specially doted molecular screen zeoliths for chemically absorbing gaseous radioactive iodine and its organic compounds.

After a core meltdown, the pressurized gas-vapor mix of the containment vessel is conducted through a highly effective accident filter into a venting chimney.

The pressure relief system prevents a failure of the containment vessel due to excessive pressure. The filter system protects the environment against airborne radioactive aerosols and iodine compounds.

Through the retention of the particulate and gaseous radioactive contaminants in the accident filter, there is a need to dissipate the decay heat so that a threshold temperature of 550° C. is not exceeded in the filter system.

In German pressurized water reactors, the decay heat for aerosols is 2 kW and for gaseous iodine is 5 kW.

In boiling water reactors and pressurized water reactors of non-German construction and other reactor types, the decay heat that needs to be dissipated from the accident filter can be 200 kW and more. In order to also cover this requirement profile, modifications in the existing filter systems are required.

### BRIEF SUMMARY OF THE INVENTION

Thus, it is an object of the present invention to improve a filter device described supra so that increased heat dissipation is achieved.

This object is achieved through a tubular element which penetrates a housing from a first pass through cross-section to a second pass through cross-section that is vertically above the first pass through cross-section so that an entire inner cavity of the tubular element is exclusively in contact with ambient air surrounding the filter device.

In an advantageous embodiment the object is achieved through A filter device for filtering a gas flow that is loaded with aerosols and/or gaseous radioactive iodine, including a housing that is closed fluid tight, including at least one raw gas inlet, a clean gas outlet, at least one filter element including a filter medium, the filter element arranged in the housing so that a gas flow to be filtered moves from the at least one raw gas inlet to the clean gas outlet exclusively through the filter element, at least one tubular element penetrating the housing from a first pass through cross-section to a second pass through cross-section which is arranged in vertical direction above the first pass through cross-section, so that an entire inner cavity of the at least one tubular element is exclusively in contact with an ambient fluid surrounding the filter device.

The joints where the tubular element penetrates the housing are closed fluid tight so that the inner cavity of the filter device and the inner cavity of the at least one tubular element are two completely separate spaces. Thus, the at least one tubular element can terminate flush with the housing or protrude beyond the housing.

According to the present invention, the significantly cooler ambient fluid of the filter device which can be ambient air or a gas mix, but can also be a liquid is run through the filter device in the tubular acting as a cooling channel, wherein the ambient air included in the tubular element is heated at the housing of the filter device and rises towards the second pass through cross-section that is arranged at a higher elevation which generates natural convection and causes cool ambient air to continuously flow through the tubular element. The orientation of the at least one tubular element is irrelevant for this purpose, the only requirement is that the end of the tubular element that is associated with the second pass through cross-section is arranged geodetically higher than the end of the tubular element associated with the first pass through cross-section, so that the heated ambient air can rise.

The at least one tubular element acting as a chimney is therefore continuously flowed through with cool ambient air, wherein the housing and the filter element included therein are continuously cooled.

This arrangement of the at least one tubular element increases the effective cooling surface of the filter device which increases the surface-volume ratio and significantly improves heat transfer.

The filter device according to the invention is characterized in particular by fail safety since the driving principle for the cooling is natural gravity.

An optimum cooling cycle is established when the at least one tubular element is vertically oriented, wherein a lower inlet surface of the tubular element is arranged at a distance from the placement surface of the filter device. The distance of the lower inlet surface from the placement surface is indispensible for the required air circulation.

Advantageously, a plurality of tubular elements is arranged at a distance from one another along the filter element. The plurality of tubular elements significantly increases the surface of the filter device that is used for cooling, wherein the tubular elements are provided where the heat development in the filter device is the greatest, namely in the portion of the filter element.

The filter device according to the invention is furthermore particular advantageous when the tubular elements arranged along the filter element are respectively offset relative to the adjacent tubular elements in longitudinal direction of the filter device by an offset dimension, wherein the offset dimension is preferably selected so that cross-sectional centers of adjacent tubular elements are arranged relative to one another at a distance of at least one quarter, preferably at least one third, further preferably at least half of a diameter of the tubular elements. Through the offset dimension, it is feasible to position the tubular elements closer together and to increase their numbers. This is feasible because the tube walls of the particular tubular elements do not block one another through the offset and furthermore do not block a pass through of the gas flow to be filtered. Through the offset dimension, the system formed from the plurality of tubular elements remains air permeable respectively between the filter stages without causing any significant throttling effect.

On the other hand side the tightly packed arrangement of the tubular elements which is facilitated by the relative offset of the tubular elements facilitates the release of heat radiation from the filter device. This is caused by the fact that the system of the offset tubular elements between the particular filter stages is essentially “opaque”, this means the heat irradiating from the filter elements towards adjacent filter elements as a matter of principle has to impact a tubular element which can dissipate this thermal energy. Direct mutual heating of the filter elements through heat radiation can be substantially prevented in this manner.

A particularly simple and durable connection of the at least one tubular element with the housing can be provided through welds.

The at least one tubular element can have a circular, triangular or square cross-section wherein also any other cross-sectional shape is feasible.

It can furthermore be advantageous when a tube wall of the at least one tubular element has a corrugated shape over the length of the tubular element. This type of configuration of the tubular elements provides higher flexibility of the tubular elements relative to tubular elements with smooth walls, wherein the housing walls where the tubular elements are attached are subjected to smaller forces due to temperature induced expansion. On the other hand side the surface areas of the enveloping surfaces of the tubular elements are increased. This is particularly advantageous with respect to the heat transfer and therefore has advantageous effects upon the cooling power provided by the filter device according to the invention.

In another advantageous embodiment, an outer enveloping surface of the at least one tubular element is coated black. This increases an absorption capability of the tubular elements relative to heat radiation which has the effect that the tubular elements absorb more heat radiation which is subsequently dissipated. This way, tubular elements of this type are particularly well-suited to remove as much thermal energy as possible from the filter device.

In order to further increase the surface of the filter device, it is particularly advantageous when the at least one tubular element has ribs or fold-overs extending over at least part of its length from an inner enveloping surface into the inner cavity of the tubular element.

According to an advantageous embodiment of the filter device according to the invention, support elements are arranged in flow direction of the gas downstream of the filter element, wherein the support elements are formed by the tube elements. Thus, the tube elements perform a double function which on the one hand side serves to improve the cooling of the filter device and on the other hand side serves to counteract a bending of the filter element that is caused by the incoming gas flow. The risk of bending the filter element exists in particular because the incoming gas flow imparts ever-increasing pressure on the filter element since its cavities are more and more clogged with filtered particles during operation of the filter device.

When the filter medium is formed by a metal fleece, the filter device is suitable for retaining large loads of airborne radioactive aerosols with high differential pressures and high temperatures.

When gaseous radioactive iodine and its organic compounds are to be retained, the filter medium is formed by a specially doted molecular screen zeolith for chemosorption.

A filter device with metal fleece can be connected in series with a filter device with a molecular screen, wherein the two devices can be optionally connected directly behind one another with a distance there between. An improvement of the filter device according to the invention provides that two or three filter elements with plural tube elements arranged thereon in series are connected one behind the other at a distance in the flow direction of the gas. Thus, it can be helpful to provide the first filter element in flow direction of the gas with coarser filter material than the subsequent filter elements.

Eventually it is advantageous when the at least one tubular element protrudes beyond a top side of the housing in order to increase the chimney effect and thus the cooling air volume flow. Thus, the geodetic height of the outlet surface of the tubular element is therefore higher than the top side of the housing. Thus, the tubular element can be configured integral in one piece so that it can be installed into the filter device with its full length. However, on order to simplify the transportation and installation of the filter device, it can be helpful to apply an additional piece of tubing to a tubular element terminating substantially flush with the housing, so that the tubular element is eventually composed from two or more pieces of tubing.

### BRIEF DESCRIPTION OF THE DRAWINGS

The invention is subsequently described in more detail based on embodiments of filter devices according to the invention with reference to drawing figures, wherein:

FIG. 1 illustrates a top view or a horizontal sectional view through a filter device according to the invention;

FIG. 2 illustrates a vertical sectional view through the filter device according to FIG. 1;

FIG. 3 illustrates a top view or a horizontal sectional view through an alternative filter device according to the invention;

FIG. 4 illustrates a vertical sectional view through another filter device according to the invention; and

FIG. 5 illustrates another filter device according to the invention.

### DETAILED DESCRIPTION OF THE INVENTION

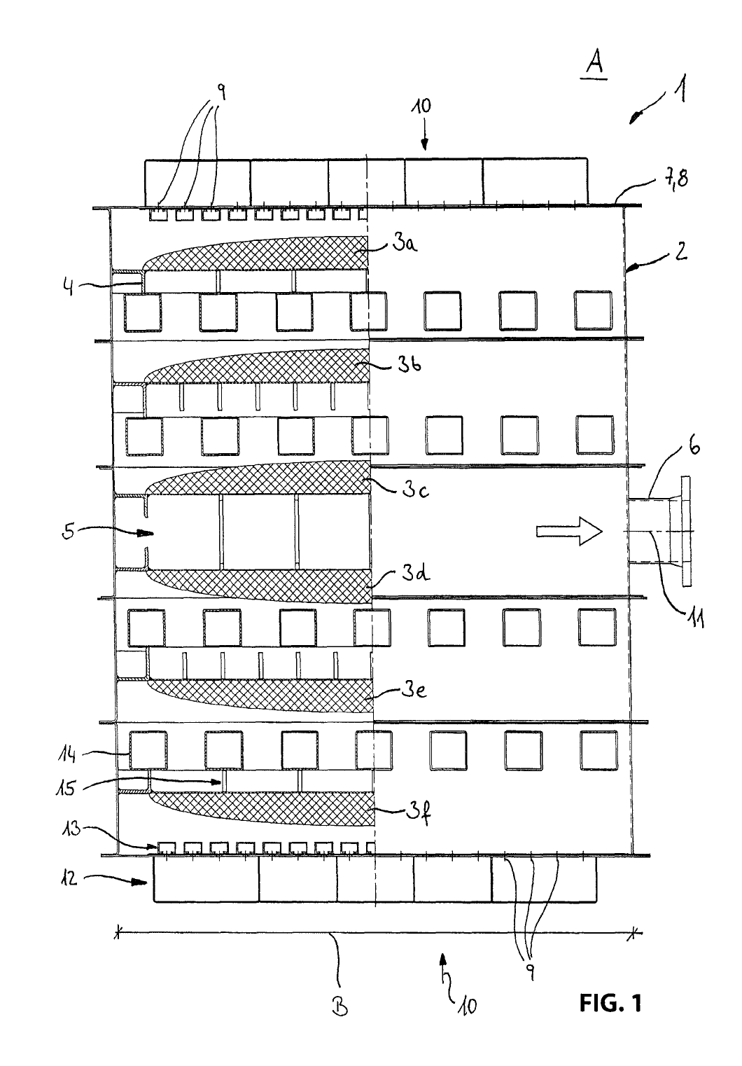

FIG. 1 illustrates a filter device 1 according to the invention in one half as a top view and in the other half as a horizontal sectional view. The filter device 1 includes an approximately cuboid housing 2 with a rectangular cross-section in which six filter elements 3a, 3b, 3c, 3d, 3e, 3f with a filter material that is formed by metal fleeces are arranged in parallel and at a distance from one another, wherein the filter elements are supported in a sealing manner respectively circumferentially at circumferentially attached consoles 4 of the housing 2 and thus respectively close the cross-section of the housing 2. The particular support of the filter elements 3 at the consoles 4 can be provided in a conventional manner and is therefore not illustrated in the figures for reasons of clarity. The filter elements 3 have a sickle shaped cross-section so that they have a small thickness along the consoles 4, whereas they are configured thicker in the center.

In the center of the housing 2, this means between the third filter element 3c and the fourth filter element 3d, there is a clean gas cavity 5 which approximately extends over a width B and over a height H and which is provided with a clean air outlet 6 on one side. The filter elements 3c, 3d do not extend over the entire height H of the clean gas cavity 5. In particular a lower end 35 of both filter elements 3c, 3d is arranged at a distance 36 from a base surface 37 of the clean gas cavity. The step that results from this distance 36 between a raw gas side and a clean gas side of both filter elements 3c, 3d shall protect against a passage of contaminated condensate into the clean gas cavity 5 in case of a possible condensation of the raw gas at the filter elements 3c, 3d.

Based on two side surfaces 7 of the housing 2 that are oriented parallel to the filter elements 3 and arranged opposite to one another and which are configured as raw gas inlets 8 having openings distributed over the lateral surfaces 7 whose center axes are indicated by short lines 9 in FIG. 1, a gas stream that is to be filtered (arrow 10) flows from both sides in a direction towards the clean gas cavity 5 and thus passes three of the six filter elements, this means either the filter elements 3a, 3b, 3c or the filter elements 3f, 3e, 3d, wherein the two filter elements 3a, 3f oriented towards the exterior portion A are configured as pre-pre-filters and the two center filter elements 3b, 3e are configured as pre-filters and the two filter elements 3c, 3d oriented towards the clean gas cavity 5 are configured as fine filters. Thus, the configuration of the filter device 1 is mirror symmetrical to a center line 11 of the clean gas outlet 6. As an alternative to this arrangement of pre-pre-filter, pre-filter and fine filter, it is also conceivable to use more or less pre-filter stages and/or to spatially disintegrate a pre-filter stage, this means to divide the pre-pre-filters 3a, 3f illustrated in the present embodiment into two filter stages connected behind one another in flow direction of the gas flow.

In order to prevent that possibly open flames in the exterior portion A of the filter device 1 reach the filter device 1, a pre-cavity 12 is respectively arranged on the outside of the raw gas inlet 8 wherein the gas flow to be filtered can only move from an open top side and an open bottom side into the pre-cavity 12. On the respective inside of the raw gas inlet 8, support elements 13 configured as C-profiles that extend over a height 34 of the housing 2 are arranged in front of the openings wherein the gas flow to be filtered can only flow into the filter device 1 from the C-profiles at their open top sides and bottom sides and at lateral gaps which are not illustrated and which are provided between the C-profiles and the housing. Subsequently the gas flows from the outer portion A initially into the pre-cavity 12 and then through the openings into the support elements 13 and eventually into the filter device 1.

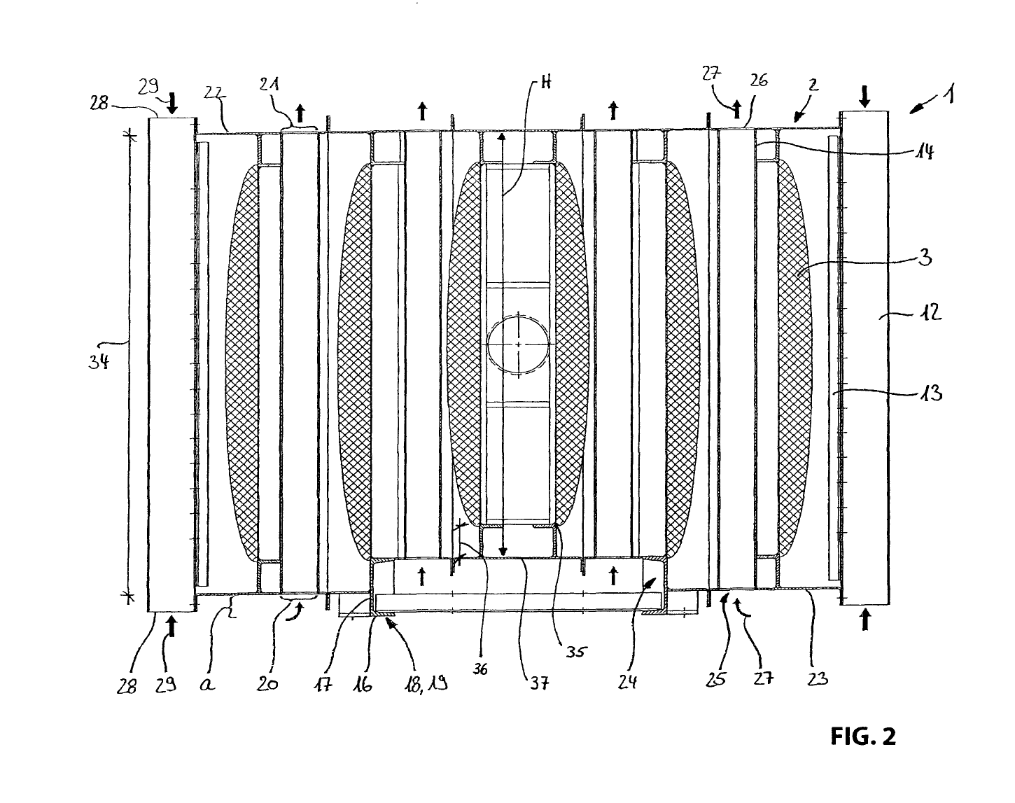

In flow direction of the gas, a series of seven tubular elements 14 with rectangular cross-sections is arranged behind each filter element 3. According to the embodiment illustrated in FIG. 1, the tubular elements 14 extend vertically and penetrate the housing 2 of the filter device 1 in an upper lateral surface and in a lower lateral surface which is visible in FIG. 2.

Directly behind the filter elements, this means between the filter elements 3 and the tubular elements 14, support elements 15 extend which support the filter elements 3 with respect to a load from the gas flow to be filtered.

FIG. 2 illustrates a vertical sectional view through the filter device 1 according to the invention from FIG. 1 which is positioned with a lower housing surface 18 formed by arms 16 of two U-profiles 17, wherein the lower housing surface 18 forms a contact surface 19 of the filter device 1, on a placement surface that is not illustrated in the Figure, like for example a floor or a pedestal.

As clearly evident from FIG. 2, the tubular elements 14 extend from a first lower pass through cross-section 20 vertically to a second upper pass through cross-section 21 in the housing 2 of the filter device 1 wherein respectively an entire inner cavity of the tubular elements 14 is exclusively in contact with the ambient fluid or the ambient air. The tubular elements 14 terminate flush with the housing 2 at an upper housing wall 22 and also at a lower housing wall 23, wherein the lower housing wall 23 includes a step 24 in the portion of the contact surface 19.

Ambient air of the filter device 1 is provided in the tubular elements 14, wherein the ambient air is also heated by the heat of the filter device 1 during operations of the filter device 1 so that natural convection is generated, wherein ambient air continuously flows through an inlet surface 25 of the tubular elements 14, wherein the ambient air leaves the tubular element 14 through an outlet surface 26 of the tubular element 14. Between the inlet surface 25 of the tubular elements 14 and the placement surface of the filter device 1 there is a distance a, which guarantees unimpeded inflow of ambient air. Through an adapter configuration that is not illustrated in the figure for connecting the filter device 1 with the building, there are much more favorable conditions for an inflow into the tubular elements 14. The flow of ambient air is indicated by the arrows 27.

FIG. 2 additionally illustrates the configuration of the raw gas inlet 8 with its pre-cavity 12, the openings in the housing wall and the support elements 13, wherein the pre-cavity 12 which protrudes beyond the housing 2 on the top side and also on the bottom side includes an upper inlet surface and a lower inlet surface 28. The flow of the gas to be filtered is indicated by the arrows 29. In order to guarantee unimpeded inflow of the gas to be filtered, the lower inlet surface 28 of the pre-cavity 12 has to have a sufficient distance from the base arranged thereunder, wherein this is for example provided when the filter device 1 is only positioned on a base in its center portion. The support elements 13 extend over the height 34 of the housing 2, wherein they respectively have a distance from the housing 2 and from the raw gas inlet 8 configured as a gap, so that the gas flow to be filtered can flow into the filter device 1.

Also in the vertical sectional view according to FIG. 2, the filter elements 3 have a sickle shaped cross-section.

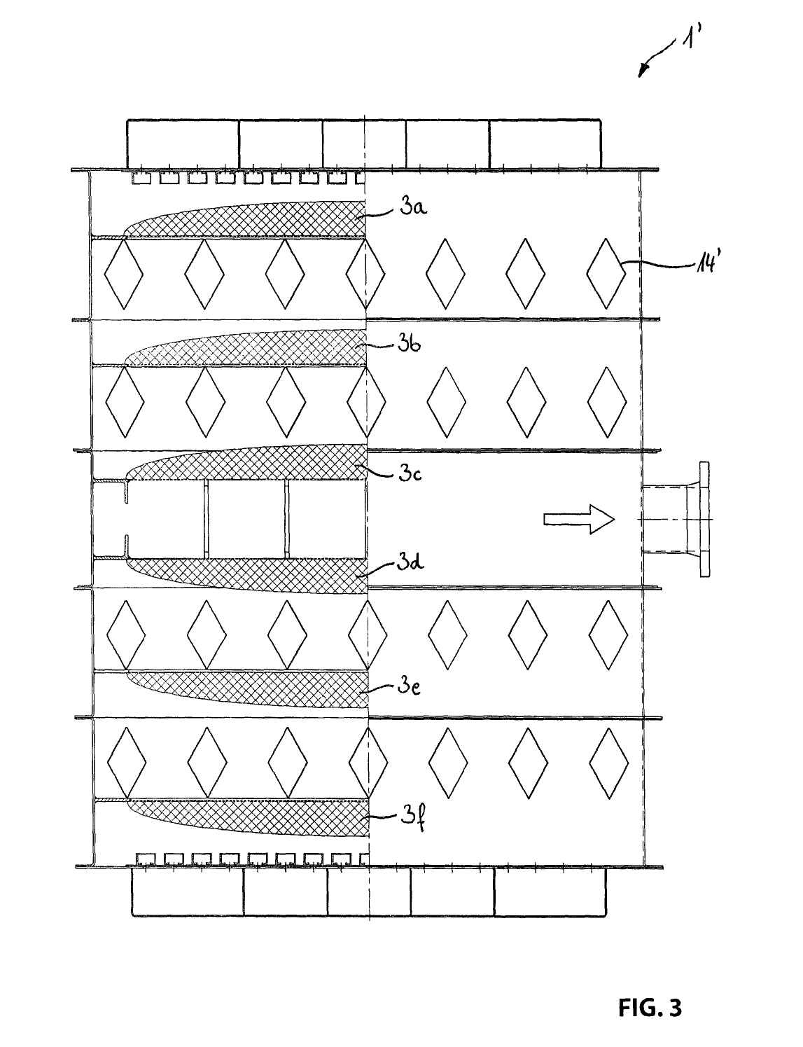

FIG. 3 relates to a second filter device 1′ according to the invention which differs from the filter device 1 through alternatively configured tubular elements 14′, wherein a horizontal sectional view and a top view of the filter device 1 is apparent from FIG. 3.

The tubular elements 14′ have diamond shaped cross-sections and extend with one of their four edges respectively along the filter elements 3, wherein the filter elements 3 are supported at the edges and separate support elements can be omitted. Consequently, the tubular elements 14′ provide support for the filter elements 3 in addition to the cooling function. The remaining configuration of the filter device 1′ overall corresponds to the configuration of the filter device 1 according to FIG. 1.

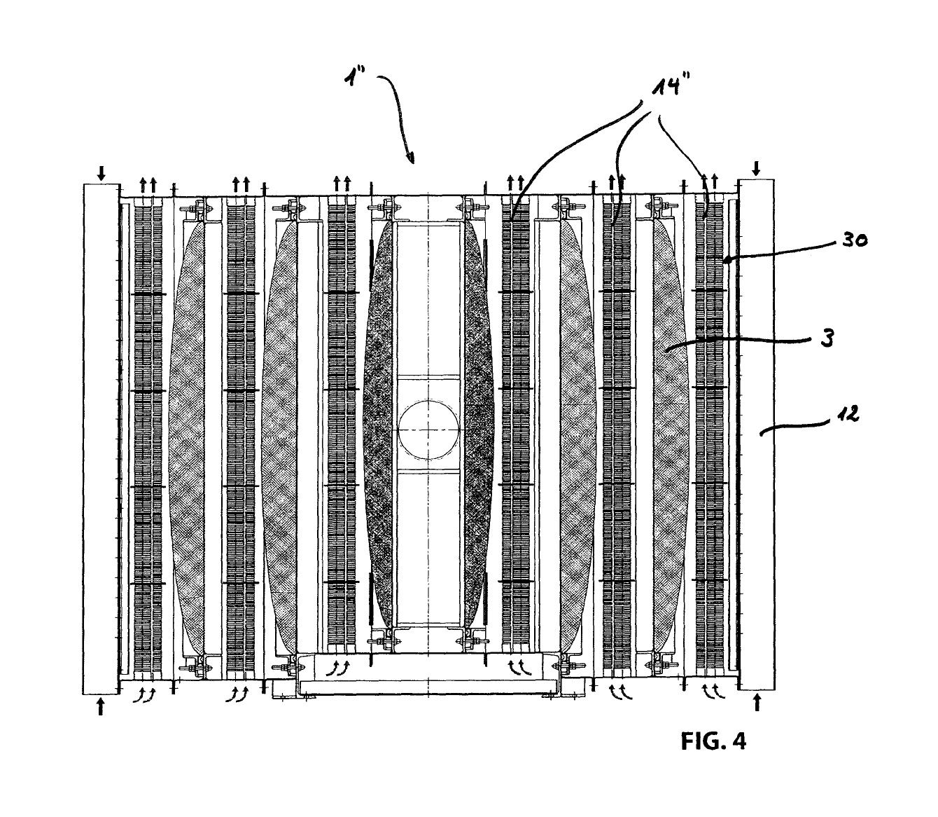

In another embodiment which is illustrated in FIG. 4, the illustrated filter device 1″ includes tubular elements 14″. These differ from the tubular elements 14, 14′ described supra through the configuration of the tubular walls 30 of the tubular elements 14″. These have a corrugated shape along a longitudinal direction of the tubular elements 14″. Tubular elements of this type are sometimes also designated as “corrugated tubes”. On the one hand side they have the advantage of higher flexibility caused by the corrugated shape. On the other hand side an enveloping surface of the corrugated tubular element 14 has a significantly larger surface than the recited tubular elements 14, 14′ with essentially “smooth” tube walls. This is particularly advantageous with respect to heat transfer since heat exchange through convection is substantially improved based on the larger surface.

In order to improve heat transfer through radiation, the tubular elements 14″ are advantageously further provided with a black coating, so that the tubular element 14′ substantially absorbs the thermal radiation imparted on it and is therefore better suited to pass on thermal energy and to consequently dissipate it from the filter device 1″.

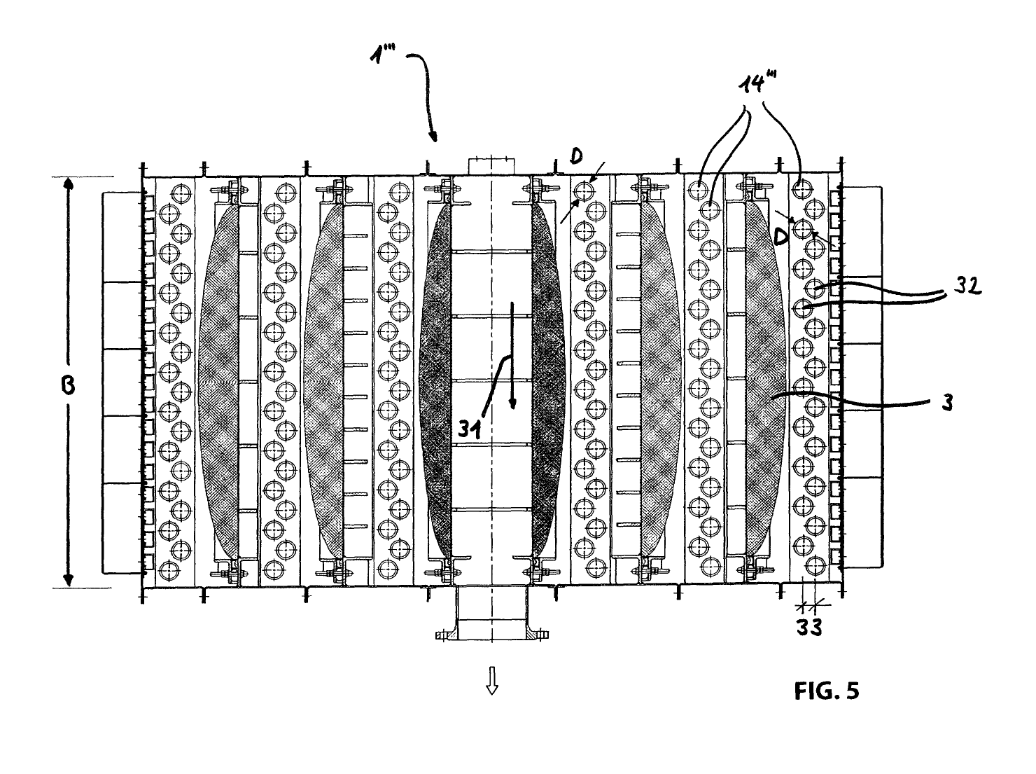

With respect to improved heat transfer through thermal radiation, furthermore the embodiment of a filter device 1′″ illustrated in FIG. 5 is advantageous. This filter device includes plural tubular elements 14′″ respectively having a circular cross-section with a diameter D of approximately 6 cm. Compared to the filter devices 1, 1′, 1″ described so far, the number and also the type of arrangement of the tubular elements 14′″ is particularly advantageous. The latter are respectively arranged offset from one another, wherein cross-section center points 32 of the cross-sections of the tubular elements 14′″ have an offset dimension 33 relative to one another viewed perpendicular to the width direction 31, wherein the offset dimension corresponds to half their diameter D, this means approximately 3 cm. Through the offset arrangement of the tubular elements 14′″, it is possible to arrange a greater number of tubular elements 14′″ in front of each filter stage over a width B of the filter device 1′″. The offset arrangement forms in particular an “opaque wall” made from the tubular elements 14′″ between the filter elements 3 which causes the heat radiation emanating from the filter elements 3 to impact the tubular elements 14′″ to a particularly large extent, wherein the tubular elements 14′″ can then dissipate this thermal energy from the filter device 1′″. As a result, the offset and therefore condensed arrangement of the tubular elements 14′″ according to the invention can further increase the cooling power of the filter device 1′″.

### REFERENCE NUMERALS AND DESIGNATIONS

1, 1′, 1″, 1′″ filter device

2 housing

3 filter element

4 console

5 clean gas cavity

6 clean gas outlet

7 lateral surface

8 raw gas inlet

9 line

10 arrow

11 center line

12 pre-cavity

13 support element

14, 14′, 14″, 14′″ tubular element

15 support element

16 arm

17 U-profile

18 lower housing surface

19 contact surface

20 lower pass through cross-section

21 upper pass through cross-section

22 upper housing wall

23 lower housing wall

24 step

25 inlet surface

26 outlet surface

27 arrow

28 inlet surface

29 arrow

30 tubular wall

31 width direction

32 cross-section center

33 offset dimension

34 height (of housing 2)

35 lower end

36 distance

37 floor surface

a distance

A exterior

B width

D diameter

H height (of clean gas cavity 5)

What is claimed is:

1. A filter device for filtering a gas flow that is loaded with at least one of aerosols and gaseous radioactive iodine, the filter device comprising:
a housing that is closed fluid tight, including
at least one raw gas inlet,
a clean gas outlet,
at least one filter element including a filter medium, the filter element arranged in the housing so that a gas flow to be filtered moves from the at least one raw gas inlet to the clean gas outlet exclusively through the filter element,
at least one tubular element penetrating the housing from a first pass through cross-section to a second pass through cross-section which is arranged in vertical direction above the first pass through cross-section, so that an entire inner cavity of the at least one tubular element is exclusively in contact with an ambient fluid surrounding the filter device.

2. The filter device according to claim 1,
wherein the at least one tubular element is vertically oriented,
wherein a lower inlet surface of the tubular element has a distance from a placement surface of the filter device.

3. The filter device according to claim 1, wherein a plurality of tubular elements is arranged along the filter element with distances from one another.

4. The filter device according to claim 2,
wherein the tubular elements arranged along the filter element are offset relative to one another in a longitudinal direction of the filter device by an offset dimension,
wherein the offset dimension is selected so that cross-sectional centers of adjacent tubular elements are arranged at a distance from one another of at least half of a diameter of the tubular elements.

5. The filter device according to claim 1, wherein the at least one tubular element is connected to the housing through welds.

6. The filter device according to claim 1, wherein the at least one tubular element has a circular, triangular or square cross-section.

7. The filter device according to claim 1, wherein a tubular wall of the at least one tubular element has a corrugated shape over its length.

8. The filter device according to claim 1, wherein an outer enveloping surface of the at least one tubular element is coated in black.

9. The filter device according to claim 1, wherein the at least one tubular element includes ribs or fold-overs extending into the inner cavity of the tubular element from an inner enveloping surface over a portion of a length of the tubular element.

10. The filter device according to claim 1,
wherein support elements are arranged in flow direction of the gas downstream of the filter element,
wherein the support elements are formed by the tubular elements.

11. The filter device according to claim 1, wherein the filter medium is formed from a metal fleece.

12. The filter device according to claim 1, wherein the filter medium is formed from a molecular screen zeolith.

13. The filter device according to claim 1, wherein two or three filter elements respectively including a series of tubular elements arranged along the filter elements are connected behind one another in flow direction of the gas.

14. The filter device according to claim 1, wherein the at least one tubular element protrudes beyond a top side or a bottom side of the housing viewed from an interior of the housing.

15. The filter device according to claim 2,
wherein the tubular elements arranged along the filter element are offset relative to one another in a longitudinal direction of the filter device by an offset dimension,
wherein the offset dimension is selected so that cross-sectional centers of adjacent tubular elements are arranged at a distance from one another of at least half of a diameter of the tubular elements.

16. The filter device according to claim 1, wherein the at least one tubular element protrudes beyond a top side and a bottom side of the housing viewed from an interior of the housing.
